(19) United States
(12) Patent Application Publication
(10) Pub. No.: US 2016/0268035 A1
(43) Pub. Date: Sep. 15, 2016

(54) VEHICLE-MOUNTED TRANSFORMER

(71) Applicant: Mitsubishi Electric Corporation, Chiyoda-ku, Tokyo (JP)

(72) Inventor: Toshihiro NODA, Chiyoda-ku, Tokyo (JP)

(73) Assignee: Mitsubishi Electric Corporation, Chiyoda-ku, Tokyo (JP)

(21) Appl. No.: 15/029,809

(22) PCT Filed: Jan. 20, 2014
(86) PCT No.: PCT/JP2014/050951

§ 371 Date: Apr. 15, 2016

(51) Int. Cl. H01F 27/12; H01F 27/28

(52) U.S. Cl. CPC H01F 27/12; H01F 27/2871

(57) ABSTRACT

A vehicle-mounted transformer comprising an iron core including a main leg, two side legs, and two pairs of connections, a winding, two covers each connected to each of opposite end faces of the iron core in a direction in which the steel plates are stacked, each of the covers surrounding the periphery of the winding together with the iron core and storing insulating oil in which the winding is immersed, and each of the covers having an opening serving as a flow path for the insulating oil, and a pump connected to the openings to circulate the insulating oil to flow from the opening in one of the covers and through two windows each surrounded by the main leg, each of the side legs and one pair of the connections toward the opening in the other cover.

### TECHNICAL FIELD

The present invention relates to vehicle-mounted transformers, and particularly to an oil-filled transformer to be mounted on a vehicle.

### BACKGROUND ART

Railroad vehicles such as a Shinkansen bullet train are required to have the maximum possible transportation capacity at a higher speed. Thus, there are conflicting demands for increased capacity as well as reduced size and weight of a vehicle-mounted transformer mounted on a railroad vehicle. Moreover, a low-floor vehicle has been increasingly introduced in recent years for the purpose of achieving a barrier-free design, with efforts being made to reduce the height of a vehicle-mounted transformer.

Japanese Utility Model Laying-Open No. 61-88222 (PTD 1) is a prior art document disclosing a dry self-cooled shell-type transformer. In the dry self-cooled shell-type transformer described in PTD 1, a side end face of an outer peripheral portion of an iron core takes on a square wave shape formed of a plurality of overhangs and recesses provided around the entire circumference along a circumferential direction of the iron core.

### CITATION LIST

### Patent Document

PTD 1: Japanese Utility Model Laying-Open No. 61-88222

### SUMMARY OF INVENTION

### Technical Problem

If a vehicle-mounted transformer is increased in capacity, a higher amount of heat is generated in an iron core and a winding, resulting in insufficient cooling capacity for a dry self-cooled transformer. If a conventional oil-filled transformer using insulating oil as a cooling medium is employed in order to ensure cooling capacity, a tank is needed to accommodate an iron core and a winding and to store the insulating oil, which leads to a larger outer shape of the vehicle-mounted transformer. Accordingly, it has been difficult to reduce the size of an oil-filled transformer to be mounted on a vehicle.

The present invention was made in view of the above-described problem, and an object of the invention is to provide a vehicle-mounted transformer that can be reduced in size and weight as well as in height while being increased in capacity.

### Solution to Problem

A vehicle-mounted transformer based on the present invention includes an iron core including a main leg, two side legs located parallel to the main leg and opposite each other with respect to the main leg, and two pairs of connections extending in a direction orthogonal to the main leg, each pair connecting opposite ends of the main leg to opposite ends of each of the side legs, the iron core being formed as one piece by joining a plurality of stacked steel plates together, a winding wound around the main leg, two covers each connected to a corresponding one of opposite end faces of the iron core in a direction in which the steel plates are stacked, each of the covers surrounding the periphery of the winding together with the iron core and storing insulating oil in which the winding is immersed, and each of the covers having an opening serving as a flow path for the insulating oil, and a pump connected to the openings to circulate the insulating oil to flow from the opening in one of the covers and through two windows each surrounded by the main leg, each of the side legs and one pair of the connections toward the opening in the other cover.

### Advantageous Effects of Invention

According to the present invention, a vehicle-mounted transformer can be reduced in size and weight as well as in height while being increased in capacity.

### BRIEF DESCRIPTION OF DRAWINGS

FIG. 1 is a perspective view showing the configuration of a vehicle-mounted transformer according to a first embodiment of the present invention.

FIG. 2 is a perspective view showing the configurations of an iron core and a winding of the vehicle-mounted transformer according to the embodiment.

FIG. 3 is a cross-sectional view of the iron core and the winding in FIG. 2 as seen from a direction of arrows of line III-III.

FIG. 4 is a cross-sectional view of the vehicle-mounted transformer in FIG. 1 as seen from a direction of arrows of line IV-IV.

FIG. 5 is a cross-sectional view of a vehicle-mounted transformer according to a second embodiment of the present invention as seen from the same direction as that of FIG. 4.

FIG. 6 is a cross-sectional view of a vehicle-mounted transformer according to a third embodiment of the present invention as seen from the same direction as that of FIG. 4.

### DESCRIPTION OF EMBODIMENTS

A vehicle-mounted transformer according to a first embodiment of the present invention will be described below with reference to the drawings. In the following description of embodiments, the same or corresponding parts in the drawings are designated by the same characters, and will not be described repeatedly.

### First Embodiment

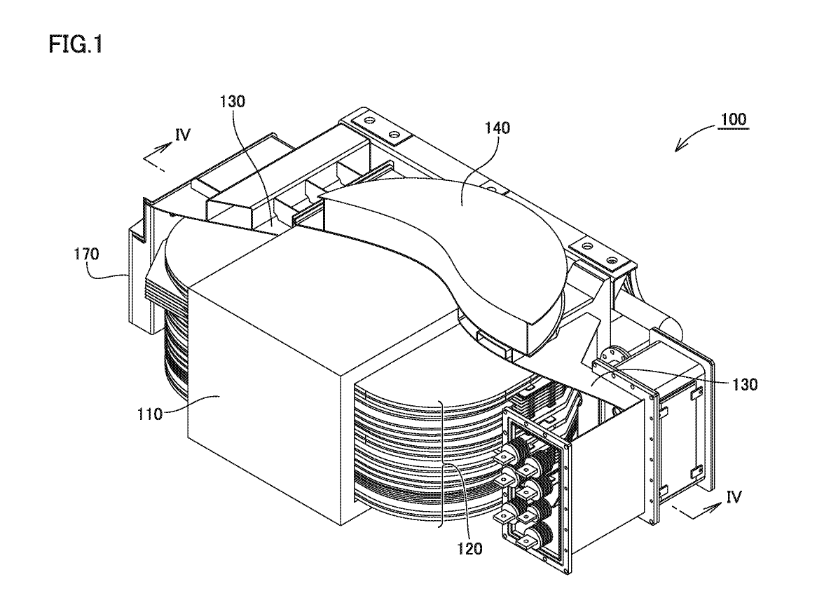

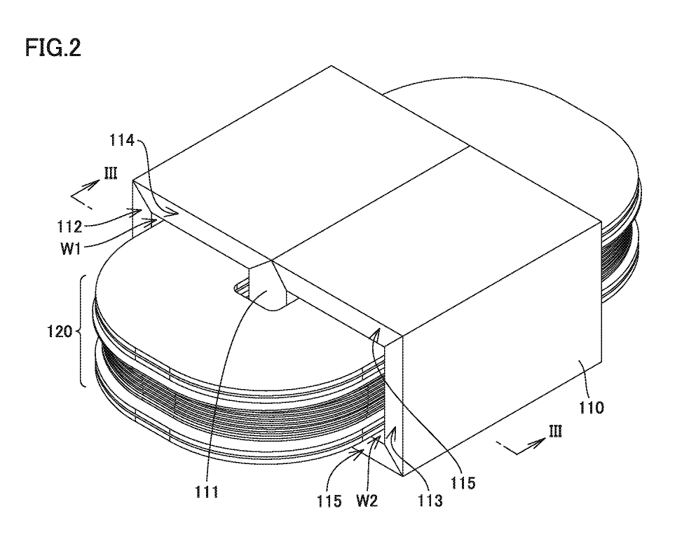

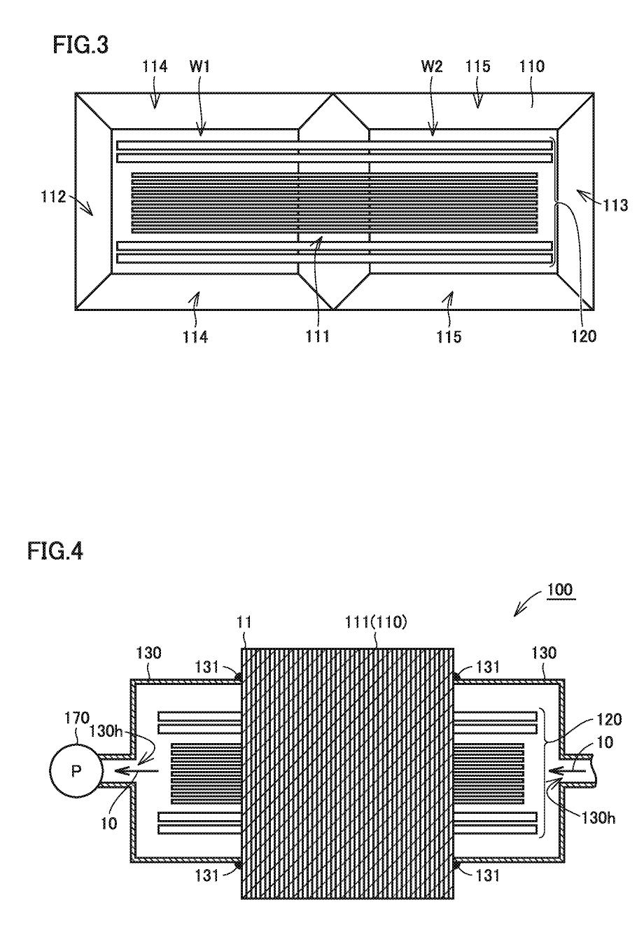

FIG. 1 is a perspective view showing the configuration of a vehicle-mounted transformer according to a first embodiment of the present invention. FIG. 2 is a perspective view showing the configurations of an iron core and a winding of the vehicle-mounted transformer according to the embodiment. FIG. 3 is a cross-sectional view of the iron core and the winding in FIG. 2 as seen from a direction of arrows of line III-III. FIG. 4 is a cross-sectional view of the vehicle-mounted transformer in FIG. 1 as seen from a direction of arrows of line IV-IV. The vehicle-mounted transformer according to the first embodiment of the present invention is mounted on a railroad vehicle.

As shown in FIGS. 1 to 4, a vehicle-mounted transformer 100 according to the first embodiment of the present invention includes an iron core 110, a winding 120, two covers 130, a conservator 140, and a pump 170.

Iron core 110 includes a main leg 111, two side legs 112, 113 located parallel to main leg 111 and opposite each other with respect to main leg 111, and two pairs of connections 114, 115 extending in a direction orthogonal to main leg 111 and connecting opposite ends of main leg 111 to opposite ends of side legs 112, 113, respectively.

Specifically, one end of main leg 111 and one end of side leg 112 are connected to each other by one of connections 114. The other end of main leg 111 and the other end of side leg 112 are connected to each other by the other connection 114. A space surrounded by main leg 111, side leg 112 and the pair of connections 114 is a window W1.

One end of main leg 111 and one end of side leg 113 are connected to each other by one of connections 115. The other end of main leg 111 and the other end of side leg 113 are connected to each other by the other connection 115. A space surrounded by main leg 111, side leg 113 and the pair of connections 115 is a window W2.

As shown in FIG. 3, iron core 110 surrounds winding 120. That is, vehicle-mounted transformer 100 according to this embodiment is a so-called shell-type transformer. Iron core 110 is formed as one piece by joining a plurality of stacked steel plates 11 together.

A surface of each steel plate 11 has an insulating coating thereon, which is an electrically insulating thermosetting resin applied on the surface. After iron core 110 and winding 120 have been assembled, the thermosetting resin is heated and cured, to thereby join steel plates 11 together into one piece.

Winding 120 is wound around main leg 111 of iron core 110 through windows W1, W2. Winding 120 includes, for example, a plurality of plate-shaped windings formed of a conductor made of copper or the like wound in the same plane.

Each of covers 130 is connected to a corresponding one of opposite end faces of iron core 110 in a direction in which steel plates 11 are stacked, surrounds the periphery of winding 120 together with iron core 110 and stores insulating oil in which winding 120 is immersed, and has an opening 130h serving as a flow path for the insulating oil.

When seen in a direction parallel to the direction in which steel plates 11 are stacked, the outer shape of cover 130 is a rectangular shape smaller than the outer shape of iron core 110. Thus, an outer peripheral surface of iron core 110 is exposed without being covered with cover 130.

Specifically, one of covers 130 is joined to each of main leg 111, side legs 112, 113 and connections 114, 115 by a welded part 131, and covers windows W1, W2 from one side of the direction in which steel plates 11 are stacked. One of covers 130 is provided with opening 130h opposite welded part 131.

The other cover 130 is joined to each of main leg 111, side legs 112, 113 and connections 114, 115 by welded part 131, and covers windows W1, W2 from the other side of the direction in which steel plates 11 are stacked. The other cover 130 is provided with opening 130h opposite welded part 131.

The insulating oil fills a space defined by one of covers 130, windows W1, W2 of iron core 110, and the other cover 130. Winding 120 is thus immersed in the insulating oil.

Opening 130h in one of covers 130 and opening 130h in the other cover 130 are connected to each other by piping, with pump 170 interposed therebetween. Pump 170 is arranged outside the space defined by one of covers 130, windows W1, W2 of iron core 110, and the other cover 130.

Pump 170 circulates the insulating oil to flow from opening 130h in one of covers 130 and through windows W1, W2 toward opening 130h in the other cover 130. Iron core 110 and winding 120 are cooled by the circulating insulating oil. The aforementioned piping serving as a flow path for the insulating oil is provided with a not-shown cooler for cooling the insulating oil.

Conservator 140 accommodates volume variation of the insulating oil. The insulating oil increases in volume when heated by heat generated by iron core 110 and winding 120. In this case, a not-shown metallic bellows of conservator 140 expands. On the other hand, the insulating oil decreases in volume when lowered in temperature. In this case, the metallic bellows of conservator 140 contracts.

Since vehicle-mounted transformer 100 is configured so as to expose the outer peripheral surface of iron core 110, there is no need for a tank to accommodate iron core 110. As a result, the outer shape of vehicle-mounted transformer 100 can be reduced in size and height. In addition, since the amount of filling insulating oil can be reduced, vehicle-mounted transformer 100 can be reduced in weight.

Furthermore, wind generated during running of the railroad vehicle contacts the outer peripheral surface of iron core 110, thereby air-cooling iron core 110. As a result, the cooler for the insulating oil can be reduced in size, which can in turn reduce the outer shape of vehicle-mounted transformer 100.

A vehicle-mounted transformer according to a second embodiment of the present invention will be described below. It is noted that a vehicle-mounted transformer 100a according to this embodiment is only different in the structure of the iron core from vehicle-mounted transformer 100 according to the first embodiment, and thus the other configurations will not be described repeatedly.

### Second Embodiment

FIG. 5 is a cross-sectional view of the vehicle-mounted transformer according to the second embodiment of the present invention as seen from the same direction as that of FIG. 4. As shown in FIG. 5, in vehicle-mounted transformer 100a according to the second embodiment of the present invention, an outer surface of an iron core 110a is provided with fin-like projections and recesses 110f in a direction orthogonal to the direction in which the steel plates are stacked. Projections and recesses 110f are provided across each of a main leg 111a, the side legs and the two pairs of connections. It is noted that the cross-sectional area of iron core 110a through which a main magnetic flux passes is the same as that of iron core 110 according to the first embodiment.

In this embodiment, projections and recesses 110f are formed by stacking steel plates 11a, 11b having different lengths from each other. Specifically, projections and recesses 110f are formed by stacking long steel plate 11a and short steel plate 11b in an alternating manner.

By providing the outer surface of iron core 110a with fin-like projections and recesses 110f in this manner, a greater air-cooling effect at an outer peripheral surface of iron core 110a can be attained. As a result, the cooler can be further reduced in size as compared to vehicle-mounted transformer 100 of the first embodiment, which can in turn reduce the outer shape of vehicle-mounted transformer 100a.

A vehicle-mounted transformer according to a third embodiment of the present invention will be described below. It is noted that a vehicle-mounted transformer 100b according to this embodiment is only different in the structure of the iron core from vehicle-mounted transformer 100 according to the first embodiment, and thus the other configurations will not be described repeatedly.

### Third Embodiment

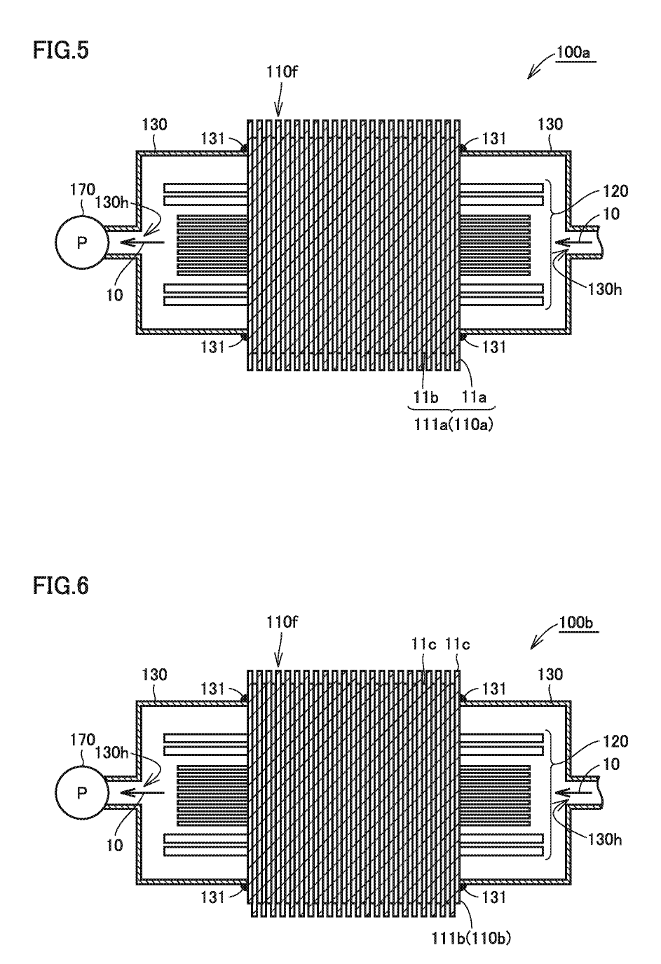

FIG. 6 is a cross-sectional view of the vehicle-mounted transformer according to the third embodiment of the present invention as seen from the same direction as that of FIG. 4. As shown in FIG. 6, in vehicle-mounted transformer 100b according to the third embodiment of the present invention, an outer surface of an iron core 110b is provided with fin-like projections and recesses 110f in the direction orthogonal to the direction in which the steel plates are stacked. Projections and recesses 110f are provided across each of a main leg 111b, the side legs and the two pairs of connections. It is noted that the cross-sectional area of iron core 110b through which a main magnetic flux passes is the same as that of iron core 110 according to the first embodiment.

In this embodiment, projections and recesses 110f are formed by stacking steel plates 11c having the same length in alternately shifted positions. By providing the outer surface of iron core 110b with fin-like projections and recesses 110f in this manner, a greater air-cooling effect at an outer peripheral surface of iron core 110b can be attained. As a result, the cooler can be further reduced in size as compared to vehicle-mounted transformer 100 of the first embodiment, which can in turn reduce the outer shape of vehicle-mounted transformer 100b. Moreover, in this embodiment, the types of steel plates used can be reduced to lower the number of components as compared to vehicle-mounted transformer 100b according to the second embodiment.

It is noted that the embodiments disclosed herein are illustrative in every respect, and do not serve as a basis for restrictive interpretation. Therefore, the technical scope of the present invention should not be interpreted based on the foregoing embodiments only, and is defined based on the description in the scope of the claims. Further, any modifications within the scope and meaning equivalent to the scope of the claims are included.

### REFERENCE SIGNS LIST

11, 11a, 11b, 11c steel plate; 100, 100a, 100b vehicle-mounted transformer; 110, 110a, 110b iron core; 110f projections and recesses; 111, 111a, 111b main leg; 112, 113 side leg; 114, 115 connection; 120 winding; 130 cover; 130h opening; 131 welded part; 140 conservator; 170 pump; W1, W2 window.

1. A vehicle-mounted transformer comprising:
an iron core including
a main leg,
two side legs located parallel to the main leg and opposite each other with respect to the main leg, and
two pairs of connections extending in a direction orthogonal to the main leg, each pair connecting opposite ends of the main leg to opposite ends of each of the side legs,
the iron core being formed as one piece by joining a plurality of stacked steel plates together;
a winding wound around the main leg;
two covers each connected to a corresponding one of opposite end faces of the iron core in a direction in which the steel plates are stacked, each of the covers surrounding the periphery of the winding together with the iron core and storing insulating oil in which the winding is immersed, and each of the covers having an opening serving as a flow path for the insulating oil; and
a pump connected to the openings to circulate the insulating oil to flow from the opening in one of the two covers and through two windows each surrounded by the main leg, each of the side legs and one pair of the connections toward the opening in the other of the two covers,
an outer shape of each of the two covers being smaller than an outer shape of the iron core when seen in a direction parallel to the direction in which the steel plates are stacked,
an outer peripheral surface of the iron core being exposed,
one of the two covers being joined to each of the main leg, the two side legs and the two pairs of connections, to cover the two windows from one side of the direction in which the steel plates are stacked,
the other of the two covers being joined to each of the main leg, the two side legs and the two pairs of connections, to cover the two windows from the other side of the direction in which the steel plates are stacked, and
the insulating oil filling a space defined by the two covers and the two windows of the iron core.

2. The vehicle-mounted transformer according to claim 1, wherein
an outer surface of the iron core is provided with fin-like projections and recesses in a direction orthogonal to the direction in which the steel plates are stacked.

3. The vehicle-mounted transformer according to claim 2, wherein
the projections and recesses are formed by stacking the steel plates having different lengths from each other.

4. The vehicle-mounted transformer according to claim 2, wherein
the projections and recesses are formed by stacking the steel plates having the same length in alternately shifted positions.
